(19) United States
(12) Patent Application Publication
(10) Pub. No.: US 2022/0226785 A1
(43) Pub. Date: Jul. 21, 2022

(54) COMPOSITION FOR FORMING SEPARATION MEMBRANE ACTIVE LAYER, METHOD FOR PRODUCING SEPARATION MEMBRANE, SEPARATION MEMBRANE, AND WATER TREATMENT MODULE

(71) Applicant: LG CHEM, LTD., Seoul (KR)

(72) Inventors: Hyelim KANG, Daejeon (KR); Lakwon CHOI, Daejeon (KR); Huizi SHEN, Daejeon (KR); Gahyeon LEE, Daejeon (KR); Chong Kyu SHIN, Daejeon (KR)

(21) Appl. No.: 17/609,072

(22) PCT Filed: Apr. 22, 2020
(86) PCT No.: PCT/KR2020/005295

§ 371 Date: Nov. 5, 2021

(30) Foreign Application Priority Data
Jun. 26, 2019 (KR) 10-2019-0076310

(51) Int. Cl. B01D 71/56; B01D 69/12; B01D 69/02; B01D 67/00; C02F 1/44

(52) U.S. Cl. CPC B01D 71/56; B01D 69/125; B01D 69/02; B01D 67/0006; C02F 1/442; C02F 2103/08; B01D 2325/34; B01D 2323/12; B01D 2323/48; B01D 2323/40; B01D 2323/22; B01D 2325/20

(57) ABSTRACT

Provided is a composition for forming a separation membrane active layer, the composition comprising a compound of the following Chemical Formula 1 and a compound of the following Chemical Formula 2,
wherein a percentage (a/b) of a weight (a) of the compound of Chemical Formula 1 to a weight (b) of the compound of Chemical Formula 2 is 30% to 60%, and
a pH thereof is 11 to 12.7:

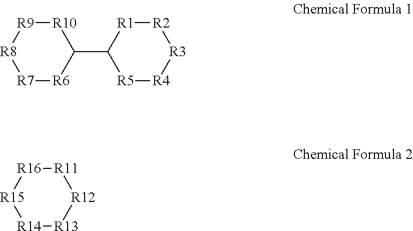

wherein in Chemical Formulae 1 and 2:
R1 to R16 are each independently —CRR′— or —NR″—.
at least two of R1 to R10 are —NR″—;
at least two of R11 to R16 are —NR″—; and
R, R′, and R″ are each independently hydrogen or a substituted or unsubstituted alkyl group;
a method for producing a separation membrane; a separation membrane; and a water treatment module.

### CROSS-REFERENCE TO RELATED APPLICATIONS

This application is a National Stage Application of International Application No. PCT/KR2020/005295 filed on Apr. 22, 2020, which claims priority to and the benefit of Korean Patent Application No. 10-2019-0076310 filed in the Korean Intellectual Property Office on Jun. 26, 2019, the entire contents of which are incorporated herein by reference.

### TECHNICAL FIELD

The present specification relates to a composition for forming a separation membrane active layer, a method for producing a separation membrane, a separation membrane produced thereby, and a water treatment module.

### BACKGROUND

Developing a new water resource has emerged as an urgent problem due to recent serious pollution of water quality environments and water shortage. Studies on the pollution of water quality environments aim for high-quality residential and industrial water, and treatment of various domestic sewage and industrial wastewater, and interests in water treatment processes using a separation membrane having an advantage of saving energy have been increasing. Further, accelerated reinforcement on environment regulations is expected to advance activation of separation membrane technologies. It is difficult for traditional water treatment processes to satisfy the tightened regulations, but separation membrane technologies secure excellent treatment efficiency and stable treatment and thus are expected to become a leading technology in the field of water treatment in the future.

Liquid separation is divided into micro filtration, ultra-filtration, nano filtration, reverse osmosis, stannizing, active transport, electrodialysis, and the like, depending on the pore of the membrane.

Among them, a nanofilter corresponding to nanofiltration is composed of a porous layer and an active layer, and is a membrane that separates a solvent and a solute using the surface charge of a separation membrane, the size of separated ions, and the reverse osmosis phenomenon. The permeate flux of the nanofilter and the selective rejection of ions are used as important indicators of membrane performance, and such performance is greatly influenced by the structure of the active layer produced by interfacial polymerization. There is a continuous need for developing a method for improving the performance of such a nanofilter.

### BRIEF DESCRIPTION

### Technical Problem

The present specification relates to a composition for forming a separation membrane active layer, a method for producing a separation membrane, a separation membrane produced thereby, and a water treatment module.

### Technical Solution

An exemplary embodiment of the present specification provides a composition for forming a separation membrane active layer, the composition including a compound of the following Chemical Formula 1 and a compound of the following Chemical Formula 2,

in which a percentage (a/b) of a weight (a) of a compound of the following Chemical Formula 1 to a weight (b) of a compound of the following Chemical Formula 2 is 30% to 60%, and

a pH thereof is 11 to 12.7:

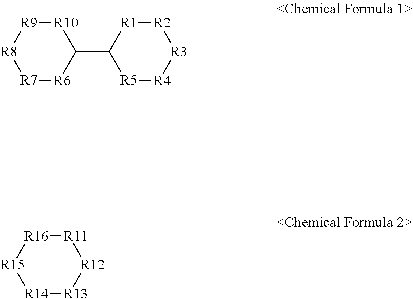

wherein in Chemical Formulae 1 and 2:

R1 to R16 are the same as or different from each other, and are each independently —CRR′— or —NR″—;

at least two of R1 to R10 are —NR″—;

at least two of R11 to R16 are —NR″—; and

R, R′, and R″ are the same as or different from each other, and are each independently hydrogen or a substituted or unsubstituted alkyl group.

An exemplary embodiment of the present specification provides a method for producing a separation membrane, the method including: preparing a porous layer; and

producing an active layer on the porous layer using the above-described composition for forming a separation membrane active layer including the compound of the following Chemical Formula 1 and the compound of the following Chemical Formula 2, in which a percentage (a/b) of a weight (a) of the compound of the following Chemical Formula 1 to a weight (b) of the compound of the following Chemical Formula 2 is 30% to 60%, and a pH thereof is 11 to 12.7:

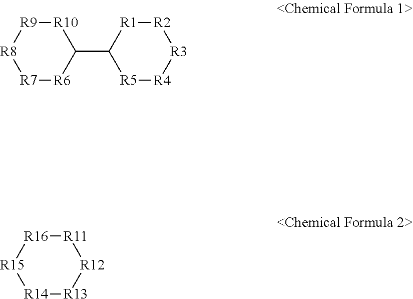

wherein in Chemical Formulae 1 and 2:

R1 to R16 are the same as or different from each other, and are each independently —CRR′— or —NR″—;

at least two of R1 to R10 are —NR″—;

at least two of R11 to R16 are —NR″—; and

R, R′, and R″ are the same as or different from each other, and are each independently hydrogen or a substituted or unsubstituted alkyl group.

An exemplary embodiment of the present specification provides a separation membrane produced by the above-described method for producing a separation membrane, in which a salt rejection measured under conditions of 2,000 ppm of an aqueous MgSO₄ solution, a pressure of 130 psi, a temperature of 25° C., and 4 L/min is 99.7% or more, and a permeate flux is 21 GFD or more.

An exemplary embodiment of the present specification provides a separation membrane produced by the above-described method for producing a separation membrane, in which the separation membrane satisfies the following Equation 1:

0.28≤Aa/Ab≤0.50 <Equation 1>

wherein Equation 1:

Aa means an absorbance value at a wave number of 1640 cm⁻¹ during an FT-IR analysis; and

Ab means an absorbance value at a wave number of 1587 cm⁻¹ during an FT-IR analysis.

Further, an exemplary embodiment of the present specification provides a water treatment module including one or more of the above-described separation membranes.

### Advantageous Effects

When a separation membrane is produced using a composition for forming a separation membrane active layer according to an exemplary embodiment of the present specification, the salt rejection and permeate flux of the separation membrane can be improved.

### BRIEF DESCRIPTION OF THE DRAWINGS

FIG. 1 illustrates a separation membrane according to an exemplary embodiment of the present specification.

FIG. 2 illustrates a water treatment module according to an exemplary embodiment of the present specification.

### DETAILED DESCRIPTION

When one member is disposed “on” another member in the present specification, this includes not only a case where the one member is brought into contact with another member, but also a case where still another member is present between the two members.

When one part “includes” one constituent element in the present specification, unless otherwise specifically described, this does not mean that another constituent element is excluded, but means that another constituent element can be further included.

In the present specification, an alkyl group can be straight-chained or branched, and the number of carbon atoms thereof is not particularly limited, but can be 1 to 30, can be 1 to 20, and can be preferably 1 to 10. Specific examples thereof include methyl, ethyl, propyl, n-propyl, isopropyl, butyl, n-butyl, isobutyl, tert-butyl, sec-butyl, 1-methyl-butyl, 1-ethyl-butyl, pentyl, n-pentyl, isopentyl, neopentyl, tert-pentyl, hexyl, n-hexyl, 1-methylpentyl, 2-methylpentyl, 4-methyl-2-pentyl, 3,3-dimethylbutyl, 2-ethylbutyl, heptyl, n-heptyl, 1-methylhexyl, cyclopentylmethyl, cyclohexylmethyl, octyl, n-octyl, tert-octyl, 1-methylheptyl, 2-ethylhexyl, 2-propylpentyl, n-nonyl, 2,2-dimethylheptyl, 1-ethyl-propyl, 1,1-dimethyl-propyl, isohexyl, 4-methylhexyl, 5-methylhexyl, and the like, but are not limited thereto.

In the present specification, a cycloalkyl group is not particularly limited, but according to an exemplary embodiment, the number of carbon atoms of the cycloalkyl group is 3 to 30. According to yet another exemplary embodiment, the number of carbon atoms of the cycloalkyl group is 3 to 20. According to yet another exemplary embodiment, the number of carbon atoms of the cycloalkyl group is 3 to 10. Specific examples thereof include a cyclopropyl group, a cyclobutyl group, a cyclopentyl group, a cyclohexyl group, a cycloheptyl group, a cyclooctyl group, and the like, but are not limited thereto.

In the present specification, the alkylene group means that there are two bonding positions in alkane. The alkylene group can be straight-chained, branched, or cyclic. The number of carbon atoms of the alkylene group is not particularly limited, but is, for example, 1 to 30, specifically 1 to 20, and more specifically 1 to 10.

In the present specification, a cycloalkylene group means that there are two bonding positions in a cycloalkane. The description on the above-described cycloalkyl group can be applied to the cycloalkane.

Hereinafter, the present specification will be described in more detail.

An exemplary embodiment of the present specification provides a composition for forming a separation membrane active layer, the composition including a compound of the following Chemical Formula 1 and a compound of the following Chemical Formula 2, in which a percentage (a/b) of a weight (a) of the compound of the following Chemical Formula 1 to a weight (b) of the compound of the following Chemical Formula 2 is 30% to 60%, and a pH thereof is 11 to 12.7:

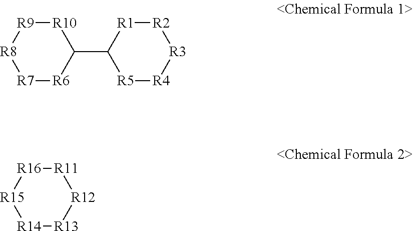

wherein in Chemical Formulae 1 and 2:

R1 to R16 are the same as or different from each other, and are each independently —CRR′— or —NR″—;

at least two of R1 to R10 are —NR″—;

at least two of R11 to R16 are —NR″—; and

R, R′, and R″ are the same as or different from each other, and are each independently hydrogen or a substituted or unsubstituted alkyl group.

When the composition for forming an active layer according to the present specification includes both the compound of Chemical Formula 1 and the compound of Chemical Formula 2, the permeate flux of the separation membrane is improved due to an increase in size of the pores included in the active layer.

Further, when the percentage (a/b) of the weight (a) of the compound of Chemical Formula 1 to the weight (b) of the compound of Chemical Formula 2 is 30% to 60%, the permeate flux can be improved without a decrease in salt rejection of the separation membrane.

In addition, when the pH of the composition for forming an active layer is 11 to 12.7, the salt rejection and permeate flux of the separation membrane can be further improved by the neutralizing action principle of HCl produced after a reaction of the compound of Chemical Formula 1 or the compound of Chemical Formula 2 and an acyl halide compound. Preferably, the pH of the composition for forming an active layer can be 12 to 12.5.

In an exemplary embodiment of the present specification, R1 to R16 are the same as or different from each other, and are each independently —CRR′— or —NR″—.

In an exemplary embodiment of the present specification, R3, R8, R12, and R15 are —NR″—, and R″ is the same as those defined in Chemical Formulae 1 and 2.

In an exemplary embodiment of the present specification, at least two of R1 to R10 are —NR″—.

In an exemplary embodiment of the present specification, at least two of R11 to R16 are —NR″—.

In an exemplary embodiment of the present specification, R, R′, and R″ are the same as or different from each other, and are each independently hydrogen or a substituted or unsubstituted alkyl group.

In an exemplary embodiment of the present specification, R, R′, and R″ are the same as or different from each other, and are each independently hydrogen or a substituted or unsubstituted alkyl group having 1 to 30 carbon atoms.

In an exemplary embodiment of the present specification, R, R′, and R″ are the same as or different from each other, and are each independently hydrogen or a substituted or unsubstituted alkyl group having 1 to 20 carbon atoms.

In an exemplary embodiment of the present specification, R, R′, and R″ are the same as or different from each other, and are each independently hydrogen or a substituted or unsubstituted alkyl group having 1 to 10 carbon atoms.

In an exemplary embodiment of the present specification, R, R′, and R″ are each hydrogen.

In an exemplary embodiment of the present specification, Chemical Formula 1 can be the following chemical compound, but is not limited thereto:

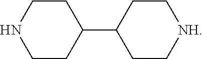 [SMILES: C1CC(C2CCNCC2)CCN1]

In an exemplary embodiment of the present specification, Chemical Formula 2 can be the following chemical compound, but is not limited thereto:

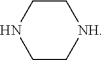

In an exemplary embodiment of the present specification, each of the compound of Chemical Formula 1 and the compound of Chemical Formula 2 is included in an amount of 0.1 wt % to 0.3 wt % based on a total weight of the composition for forming an active layer.

Preferably, each of the compound of Chemical Formula 1 and the compound of Chemical Formula 2 is included in an amount of 0.11 wt % to 0.25 wt % based on a total weight of the composition for forming an active layer.

Specifically, the compound of Chemical Formula 1 is included in an amount of 0.11 wt % to 0.21 wt % based on a total weight of the composition for forming an active layer.

More specifically, the compound of Chemical Formula 2 is included in an amount of 0.14 wt % to 0.25 wt % based on a total weight of the composition for forming an active layer.

When each of the compound of Chemical Formula 1 and the compound of Chemical Formula 2 satisfies the above weight range, the permeate flux can be improved without a decrease in salt rejection.

In an exemplary embodiment of the present specification, the pH of the composition for forming a separation membrane active layer is 11 to 12.7.

When the composition for forming an active layer satisfies the above pH range, an active layer polymerization reaction can be performed, so that the salt rejection of the separation membrane can be secured at 97% or more, preferably 99.7% or more.

When the pH of the composition for forming an active layer is less than 11, the active layer polymerization reaction does not occur, and when the pH is more than 12.7, the salt rejection of the separation membrane drops significantly to less than 95%.

The composition for forming an active layer can further include salts of triethylamine and camphor sulfonic acid.

Based on a total weight of the composition for forming an active layer, the salts of triethylamine and camphor sulfonic acid in the composition for forming an active layer can be included in an amount of 4 wt % to 9 wt %. Preferably, the salts of triethylamine and camphor sulfonic acid can be included in an amount of 5 wt % to 7 wt %.

Furthermore, the composition for forming an active layer can include sodium hydroxide (NaOH) in order to satisfy the pH range of the composition for forming an active layer.

An exemplary embodiment of the present specification provides a composition for forming a separation membrane active layer, the composition further including: a surfactant; a hydrophilic polymer compound; and a solvent.

As the surfactant, for example, sodium lauryl sulfate (SLS) or sodium dodecyl benzene sulfonate can be used, but the surfactant is not limited thereto. Preferably, the surfactant can be sodium lauryl sulfate (SLS).

The surfactant can be included in an amount of 0.05 wt % to 1 wt % in the composition for forming an active layer, based on a total weight of the composition for forming an active layer. When the surfactant is included within the above range, the composition for forming an active layer has an effect of being uniformly applied to the surface of the porous layer.

Examples of the hydrophilic polymer compound include polyvinyl alcohol (PVA), polyethylene oxide, polyacrylic acid, and polyethylene glycol, but are not limited thereto. Preferably, the hydrophilic polymer compound can be polyvinyl alcohol (PVA).

The hydrophilic polymer compound can be included in an amount of 0.05 wt % to 1 wt % in the composition for forming an active layer, based on a total weight of the composition for forming an active layer. When the hydrophilic polymer compound is included within the above range, the mechanical strength of the active layer can be secured.

The solvent can be water, and the balance obtained by removing the amine compound from the composition for forming an active layer can be water.

An exemplary embodiment of the present specification provides a method for producing a separation membrane, the method including: preparing a porous layer; and producing an active layer on the porous layer using the above-described composition for forming a separation membrane active layer including the compound of the following Chemical Formula 1 and the compound of the following Chemical Formula 2, in which a percentage (a/b) of a weight (a) of the compound of the following Chemical Formula 1 to a weight (b) of the compound of the following Chemical Formula 2 is 30% to 60%, and a pH thereof is 11 to 12.7:

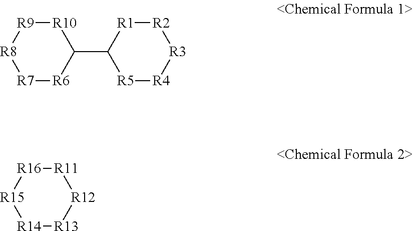

wherein in Chemical Formulae 1 and 2:

R1 to R16 are the same as or different from each other, and are each independently —CRR′— or —NR″—;

at least two of R1 to R10 are —NR″—;

at least two of R11 to R16 are —NR″—; and

R, R′, and R″ are the same as or different from each other, and are each independently hydrogen or a substituted or unsubstituted alkyl group.

In the method for producing a separation membrane, the definitions of Chemical Formula 1 and Chemical Formula 2 are the same as described above.

In an exemplary embodiment of the present specification, the producing of the active layer using the composition for forming an active layer includes interfacial polymerization of the composition for forming an active layer and an organic solution including an acyl halide compound.

Specifically, when the composition for forming an active layer is brought into contact with the organic solution, a polyamide is formed by interfacial polymerization while the amine compound coated on the surface of the support layer and a polyfunctional acyl halide compound react with each other, and the polyamide is adsorbed onto the support layer to form a thin film. In the contact method, the polyamide active layer can be formed by a method such as immersion, spray, or coating.

An organic solution including the acyl halide compound include an acyl halide compound and an organic solvent.

According to an exemplary embodiment of the present specification, the acyl halide compound is not particularly limited, but can be, for example, a mixture of one or more selected from the group consisting of trimesoyl chloride (TMC), isophthaloyl chloride, terephthaloyl chloride, and a mixture thereof, as an aromatic compound having 2 to 3 carboxylic acid halides. Preferably, the acyl halide compound is trimesoyl chloride (TMC).

According to an exemplary embodiment of the present specification, a content of the acyl halide compound can be 0.2 wt % to 0.8 wt % based on the total weight of the composition for forming an active layer of a reverse osmosis membrane. Preferably, the content of the acyl halide compound can be 0.4 wt % to 0.5 wt %.

As the organic solvent, it is possible to use an aliphatic hydrocarbon solvent, for example, Freons and a hydrophobic liquid which is immiscible with water, such as hexane, cyclohexane, heptane, and an alkane, which have 5 to 12 carbon atoms, for example, an alkane having 5 to 12 carbon atoms, and IsoPar (Exxon), ISOL-C(SK Chem.), ISOL-G (Exxon), IsoPar G, and the like, which are a mixture thereof, but the organic solvent is not limited thereto.

According to an exemplary embodiment of the present specification, the balance obtained by removing the acyl halide compound from the organic solution including the acyl halide compound can be the organic solvent.

In an exemplary embodiment of the present specification, the preparing of the porous layer includes: preparing a first porous support; and forming a second porous support which is a coating layer of a polymer material on the first porous support.

That is, the porous layer includes a first porous support and a second porous support.

In an exemplary embodiment of the present specification, the first porous support is a non-woven fabric and the second porous support is a polysulfone layer.

As the first porous support, a non-woven fabric can be used. As a material for the non-woven fabric, polyethylene terephthalate can be used, but the material is not limited thereto.

A thickness of the non-woven fabric can be 50 μm to 150 μm, but is not limited thereto. Preferably, the thickness can be 80 μm to 120 μm. When the thickness of the non-woven fabric satisfies the above range, the durability of a gas separation membrane including the porous layer can be maintained.

The second porous support can mean that a coating layer of a polymer material is formed on the first porous support. As the polymer material, it is possible to use, for example, polysulfone, polyethersulfone, polycarbonate, polyethylene oxide, polyimide, polyetherimide, polyether ether ketone, polypropylene, polymethylpentene, polymethyl chloride, polyvinylidene fluoride, or the like, but the polymer material is not limited thereto. Specifically, as the polymer material, polysulfone can be used. That is, the second porous support is a polysulfone layer.

A thickness of the second porous support can be 20 μm to 200 μm, but is not limited thereto. Preferably, the thickness can be 40 μm to 160 μm. When the thickness of the coating layer satisfies the above range, the durability of a separation membrane including the porous layer including the second porous support can be appropriately maintained.

According to an example, the second porous support can be produced from a polymer solution including the polysulfone. The polymer solution including the polysulfone can be a homogeneous liquid phase obtained after 10 wt % to 20 wt % of a polysulfone solid is put into 80 wt % to 90 wt % of a solvent dimethylformamide based on a total weight of a polymer solution including the polysulfone, and the resulting mixture is dissolved at 80° C. to 85° C. for 12 hours, but the weight range is not limited to the above range.

When the polysulfone solid within the above range is included based on the total weight of the polymer solution including the polysulfone, the durability of the separation membrane including the second porous support can be appropriately maintained.

The second porous support can be formed by a casting method. The casting means a solution casting method, and specifically can mean a method of dissolving the polymer material in a solvent, developing the resulting solution on a smooth surface having no adhesion, and then substituting the solvent. Specifically, a non-solvent induced phase separation method can be used as a method for substituting the above solvent. The non-solvent induced phase separation method is a method of preparing a uniform solution by dissolving a polymer in a solvent, molding the uniform solution into a predetermined shape, and then immersing the resulting molded article in a non-solvent, in which the non-solvent and the solvent are then interchanged by diffusion of the non-solvent and the solvent, the composition of the polymer solution is changed, and a portion occupied by the solvent and the non-solvent is formed of pores while the polymer is precipitated.

In an exemplary embodiment of the present specification, the method further includes producing a protective layer on the active layer after producing of the active layer.

The protective layer is produced by a composition for forming a protective layer, and the composition for forming a protective layer includes polyvinyl alcohol, polyethylene glycol, or glycerol. Preferably, the composition for forming a protective layer includes polyvinyl alcohol.

The polyvinyl alcohol can be included in an amount of 0.1 wt % to 3 wt % in the composition for forming a protective layer, based on a total weight of the composition for forming a protective layer. When the polyvinyl alcohol is included within the above range, the active layer can be protected from physical damage.

In the composition for forming a protective layer, water can be used as a solvent, but the solvent is not limited thereto.

By further including the protective layer, the separation membrane according to the present specification can improve contamination resistance and durability while minimizing a decrease in permeate flux.

The producing of the protective layer on the active layer can be performed, for example, by a method of immersing a porous layer in which a polyamide active layer is formed in the composition for forming a protective layer, and can be performed by a method of applying the above-described composition for forming a protective layer on the porous layer in which a polyamide active layer is formed, but the method is not limited thereto.

Meanwhile, the immersion time can be appropriately adjusted in consideration of the thickness of a protective layer to be formed and the like, and is, for example, about 0.1 minute to 10 hours, preferably about 1 minute to 1 hour. There are negative effects that when the immersion time is less than 0.1 minute, the protective layer is not sufficiently formed, and when the immersion time is more than 10 hours, the thickness of the protective layer becomes so large that the permeate flux of the separation membrane is decreased.

According to an exemplary embodiment of the present specification, the protective layer can have a thickness of 100 nm to 300 nm. When the protective layer has a thickness less than 100 nm, the active layer can be easily damaged, and when the protective layer has a thickness more than 300 nm, the permeate flux and salt rejection of the separation membrane can be decreased.

An exemplary embodiment of the present specification provides a separation membrane produced by the above-described method for producing a separation membrane, in which a salt rejection measured under conditions of 2,000 ppm of an aqueous MgSO₄ solution, a pressure of 130 psi, a temperature of 25° C., and 4 L/min is 99.7% or more, and a permeate flux is 21 GFD or more.

The salt rejection is preferably 99.7% to 99.9%, and more preferably 99.77% to 99.85%.

The permeate flux is preferably 21 GFD to 29 GFD, and more preferably 21.16 GFD to 25.85 GFD.

When the separation membrane according to the present specification satisfies the above-described salt rejection and permeate flux, the separation membrane can be easily used for separating sulfuric acid ions (SO₄²⁻) in seawater.

In the present specification, the GFD is a unit of permeate flux, and means gallons/ft²/day.

An exemplary embodiment of the present specification provides a separation membrane produced by the above-described method for producing a separation membrane, in which the separation membrane satisfies the following Equation 1:

0.28≤Aa/Ab≤0.50 <Equation 1>

wherein in Equation 1:

Aa means an absorbance value at a wave number of 1640 cm⁻¹ during an FT-IR analysis; and

Ab means an absorbance value at a wave number of 1587 cm⁻¹ during an FT-IR analysis.

Specifically, the spectrum can be measured using a Cary 660 FT-IR spectrometer during an FT-IR analysis, but the measurement method is not limited thereto.

In an exemplary embodiment of the present specification, preferably, 0.31 Aa/Ab 0.49, and more preferably, 0.32 Aa/Ab 0.48.

When the interval of a wave number of 1800 cm⁻¹ to 1000 cm⁻¹ is analyzed during an FT-IR analysis of a separation membrane produced by the above-described method for producing a separation membrane, it is possible to confirm a ratio of the thickness of the active layer to the thickness of the porous layer included in the separation membrane according to the content ratio of a sulfone group and an amide group included in the separation membrane. The sulfone group is included in a polysulfone of the porous layer, and the amide group is included in a polyamide of the active layer.

When the Aa/Ab value of Equation 1 satisfies a range of 0.28≤Aa/Ab≤0.50, the thickness of an active layer produced by interfacial polymerization of the organic solution including the composition for forming an active layer and the acyl halide compound as described above compared to thickness of the porous layer is so small that the case means that it is possible to satisfy the salt rejection and permeate flux of the separation membrane intended by the present specification. When the Aa/Ab value is less than 0.28, the thickness of the active layer is so small that the salt rejection of the separation membrane including the active layer is rapidly decreased, and when the Aa/Ab value is more than 0.50, the thickness of the active layer is so large that the permeate flux of the separation layer including the active layer is decreased.

In an exemplary embodiment of the present specification, the separation membrane can be a micro filtration membrane, an ultra-filtration membrane, a nano filtration membrane or a reverse osmosis membrane. Preferably, the separation membrane can be a nano filtration membrane.

An exemplary embodiment of the present specification provides a water treatment module including one or more of the separation membranes.

The number of reverse osmosis membranes included in the water treatment module can be 1 to 50, 1 to 30, and preferably 24 to 28, but is not limited thereto.

The specific kind of water treatment module is not particularly limited, and examples thereof include a plate & frame module, a tubular module, a hollow & fiber module, or a spiral wound module, and the like.

Furthermore, the other constitutions, producing methods thereof, and the like are not particularly limited as long as the water treatment module of the present invention includes the above-described separation membrane, and a general means publicly known in this field can be adopted without limitation.

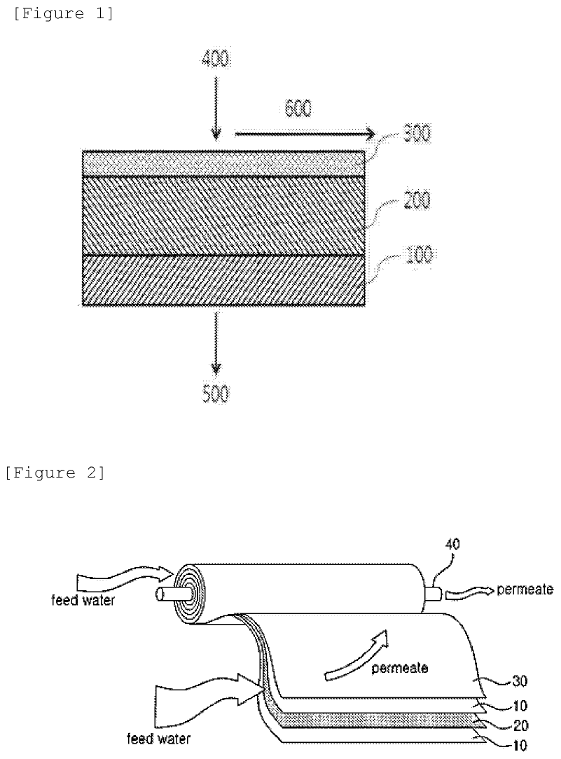

FIG. 1 illustrates a separation membrane according to an exemplary embodiment of the present specification. Specifically, FIG. 1 illustrates a separation membrane in which a porous layer including a first porous support 100 and a second porous support 200; and an active layer 300 are sequentially provided, and saltwater 400 flows into an active layer 300, so that purified water 500 is released through a support 100, and concentrated water 600 is released to the outside without passing through the active layer 300.

FIG. 2 illustrates a water treatment module according to an exemplary embodiment of the present specification. Specifically, the water treatment module is configured to include a central tube 40, a feed spacer 20, a separation membrane 10, a tricot filtration channel 30, and the like. When raw water is flowed through the water treatment module, the raw water flows in through the feed spacer 20 in the water treatment module. One or more separation membranes 10 extend outward from the tube 40 and are wound around the tube 40. The feed spacer 20 forms a passage through which raw water flows in from the outside, and serves to maintain a distance between one separation membrane 10 and the other separation membrane 10. For this purpose, the feed spacer 20 is brought into contact with one or more separation membranes 10 on the upper and lower sides and is wound around the tube 40. The tricot filtration channel 30 generally has a structure in the form of a woven fabric, and serves as a channel that creates a space for enabling purified water to flow through the separation membrane 10. The tube 40 is located in the center of the water treatment module, and serves as a passage for filtered water to flow in and out. In this case, since it is preferred that pores having a predetermined size are formed on the outside of the tube 40 such that the filtered water flows in, it is preferred that one or more pores are formed. As the separation membrane 10 includes an active layer 300 produced by the composition for forming the active layer, the separation membrane performance of salt rejection and/or flux can be improved.

### EXAMPLES

Hereinafter, the present specification will be described in detail with reference to Examples for specifically describing the present specification.

However, the Examples according to the present specification can be modified in various forms, and it is not interpreted that the scope of the present specification is limited to the Examples described below in detail. The Examples of the present specification are provided to explain the present specification more completely to a person with ordinary skill in the art.

### Preparation Examples

### Example 1

(Production of Porous Layer)

A non-woven fabric was used as a first porous support, the non-woven fabric was polyethylene terephthalate, and a polyethylene terephthalate having a thickness of 100 μm was used.

A polymer solution including polysulfone was prepared in order to produce a polysulfone layer which is a second porous support on the first porous support. The polymer solution including polysulfone was a homogeneous liquid phase obtained after 15 wt % of a polysulfone solid was put into 85 wt % of the solvent dimethylformamide, based on a total weight of the polymer solution including polysulfone, and the resulting mixture was dissolved at 80 to 85° C. for 12 hours.

Thereafter, a second porous support (polysulfone layer) was produced by casting a polymer solution including the polysulfone at 40 μm on the first porous support (polyethylene terephthalate) by a slot die coating method. Through this, a porous layer including the first porous support and a polysulfone layer was produced.

(Production of Active Layer)

In order to produce an active layer on the porous layer, a composition for forming an active layer was prepared. 0.11 wt % of 4,4′-bipiperidine, which is a compound of Chemical Formula 1, and 0.25 wt % of piperazine, which is a compound of Chemical Formula 2, based on a total weight of the composition for forming an active layer, were put into the composition for forming an active layer, and 6 wt % of triethylamine/camphor sulfonic acid was added thereto in the form of a salt, and sodium hydroxide (NaOH) was added thereto in order to adjust the pH of the composition for forming an active layer to 12.5.

Further, in order to uniformly apply a composition for forming an active layer on the surface of a porous layer, a surfactant of sodium lauryl sulfate (SLS) and a hydrophilic polymer compound of polyvinyl alcohol were added thereto in an amount of 0.5 wt % and 0.5 wt %, respectively based on a total weight of the composition for forming an active layer. Moreover, a composition for forming an active layer was prepared by including the balance water.

Thereafter, an aqueous solution layer was formed by applying the prepared composition for forming an active layer on the porous layer. Furthermore, an extra aqueous solution generated during the application was removed by using an air knife.

An organic solution including an acyl halide compound was applied on the aqueous solution layer. The organic solution including the acyl halide compound was prepared by including 0.45 wt of trimesoyl chloride (TMC) and the balance organic solvent (IsoPar G) based on a total weight of the organic solution including the acyl halide compound.

Then, a separation membrane was produced by drying the liquid phase components in an oven at 95° C. until all of the liquid phase components were evaporated, and then washing the residue with ultra-pure water (DIW).

After an aqueous polyvinyl alcohol solution which is a composition for forming a protective layer was applied on the surface of the washed separation membrane, a final separation membrane was produced by removing an extra aqueous solution using an air knife, and drying the liquid phase compounds under a condition of 85° C. until all of the liquid phase components were evaporated. The composition for forming a protective layer was prepared by including 3 wt % of polyvinyl alcohol and the balance water based on a total weight of the composition for forming a protective layer.

### Examples 2 to 4

A separation membrane was produced in the same manner as in Example 1, except that the amount of each of the compound of Chemical Formula 1 and the compound of Chemical Formula 2 included in the composition for forming an active layer, are as described in the following Table 1, were applied in Example 1.

### Comparative Examples 1 to 5

A separation membrane was produced in the same manner as in Example 1, except that the amount of each of the compound of Chemical Formula 1 and the compound of Chemical Formula 2 included in the composition for forming an active layer, are as described in the following Table 1, were applied in Example 1.

### Comparative Examples 6 to 9

A separation membrane was produced in the same manner as in Example 1, except that the amount of each of the compound of Chemical Formula 1 and the compound of Chemical Formula 2 included in the composition for forming an active layer, are as described in the following Table 1, were applied in Example 1 and a pH thereof was adjusted to 10 by adding no sodium hydroxide thereto in Example 1.

TABLE 1

| | wt % of compound | wt % of compound | | |
|---|---|---|---|---|
| | (4,4′-bipiperidine) | (piperazine) (b) | a/b | |
| | (a) of Chemical | of Chemical | percentage | |
| | Formula 1 | Formula 2 | (%) | pH |
| Example 1 | 0.11 | 0.25 | 30 | 12.5 |
| Example 2 | 0.14 | 0.21 | 40 | 12.5 |
| Example 3 | 0.18 | 0.18 | 50 | 12.5 |
| Example 4 | 0.21 | 0.14 | 60 | 12.5 |
| Comparative | 0 | 0.35 | 0 | 12.5 |
| Example 1 | | | | |
| Comparative | 0.04 | 0.32 | 10 | 12.5 |
| Example 2 | | | | |
| Comparative | 0.07 | 0.28 | 20 | 12.5 |
| Example 3 | | | | |
| Comparative | 0.26 | 0.09 | 75 | 12.5 |
| Example 4 | | | | |
| Comparative | 0.35 | 0 | 100 | 12.5 |
| Example 5 | | | | |
| Comparative | 0.11 | 0.25 | 30 | 10 |
| Example 6 | | | | |
| Comparative | 0.14 | 0.21 | 40 | 10 |
| Example 7 | | | | |
| Comparative | 0.18 | 0.18 | 50 | 10 |
| Example 8 | | | | |
| Comparative | 0.21 | 0.14 | 60 | 10 |
| Example 9 | | | | |

### Experimental Examples

(Measurement of Performance of Separation Membrane)

Measurement of Salt Rejection and Permeate Flux

After it was confirmed that the separation membranes produced in Examples 1 to 4 and Comparative Examples 1 to 9 were stabilized by performing an operation of an apparatus using 2,000 ppm of an aqueous MgSO₄ solution at a flux of 4 L/min under 800 psi for approximately 1 hour, the results of calculating the permeate flux (gallon/ft²/day (GFD)) by measuring an amount of water permeated at 25° C. for 10 minutes, and calculating the salt rejection by analyzing the salt concentration before and after the permeation using a conductivity meter, are shown in the following Table 2.

TABLE 2

| | Salt rejection (%) | Permeate flux (GFD) |
|---|---|---|
| Example 1 | 99.77 | 21.16 |
| Example 2 | 99.81 | 25.85 |
| Example 3 | 99.85 | 24.46 |
| Example 4 | 99.84 | 25.14 |
| Comparative | 99.95 | 16.61 |
| Example 1 | | |
| Comparative | 99.87 | 13.21 |
| Example 2 | | |
| Comparative | 99.83 | 14.41 |
| Example 3 | | |
| Comparative | 98.81 | 32.44 |
| Example 4 | | |
| Comparative | 97.75 | 53.27 |
| Example 5 | | |
| Comparative | 75.89 | 17.65 |
| Example 6 | | |
| Comparative | 79.14 | 18.21 |
| Example 7 | | |
| Comparative | 74.95 | 16.58 |
| Example 8 | | |
| Comparative | 73.51 | 18.39 |
| Example 9 | | |

According to Table 2, it can be confirmed that compared to the separation membranes in Comparative Examples 1 to 9, the separation membranes in Examples 1 to 4 have a permeate flux of 21 GFD or more while maintaining a salt rejection at 99.7% or more.

Thereby, it can be confirmed that the separation membrane according to the present specification has excellent performance.

(Measurement of Thickness of Active Layer Through FT-IR Analysis)

In the separation membranes produced by Examples 1 to 4 and Comparative Examples 1 to 5, the interval of a wave number of 1800 cm⁻¹ to 1000 cm⁻¹ was analyzed using a Cary 660 FT-IR spectrometer. Specifically, an absorbance value at a wave number of 1640 cm⁻¹ was measured, and is described as Aa in the following Table 3, and an absorbance value at a wave number of 1587 cm⁻¹ was measured, and is described as Ab in the following Table 3. Moreover, an Aa/Ab value was calculated, and is described in the following Table 3.

TABLE 3

| | Aa | Ab | Aa/Ab |
|---|---|---|---|
| Example 1 | 0.172 | 0.36 | 0.48 |
| Example 2 | 0.140 | 0.36 | 0.39 |
| Example 3 | 0.124 | 0.36 | 0.34 |
| Example 4 | 0.114 | 0.36 | 0.32 |
| Comparative Example 1 | 0.186 | 0.36 | 0.52 |
| Comparative Example 2 | 0.184 | 0.36 | 0.51 |
| Comparative Example 3 | 0.183 | 0.36 | 0.51 |
| Comparative Example 4 | 0.096 | 0.36 | 0.27 |
| Comparative Example 5 | 0.087 | 0.36 | 0.24 |

According to Table 3, it could be confirmed that the Aa/Ab values in Examples 1 to 4 satisfied 0.28≤Aa/Ab≤0.50, and thus the thickness of an active layer produced by interfacial polymerization of the organic solution including the composition for forming an active layer and the acyl halide compound as described above compared to the thickness of a porous layer was so small that it was possible to satisfy the salt rejection and permeate flux of the separation membrane intended by the present specification.

Although the preferred exemplary embodiments of the present invention have been described above, the present invention is not limited thereto, and various modifications can be made and carried out within the scopes of the claims and the detailed description of the invention, and also fall within the scope of the invention.

### EXPLANATION OF REFERENCE NUMERALS AND SYMBOLS

10: Separation membrane
20: Feed spacer
30: Tricot filtration channel
40: Tube
100: First porous support
200: Second porous support
300: Active layer
400: Saltwater
500: Purified water
600: Concentrated water

1. A composition for forming a separation membrane active layer, the composition comprising a compound of the following Chemical Formula 1 and a compound of the following Chemical Formula 2,
wherein a percentage (a/b) of a weight (a) of the compound of Chemical Formula 1 to a weight (b) of the compound of Chemical Formula 2 is 30% to 60%, and
a pH thereof is 11 to 12.7: 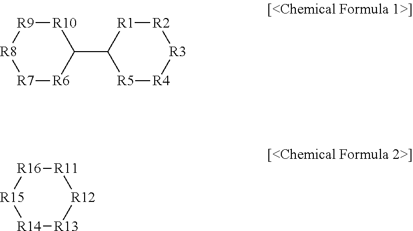
wherein in Chemical Formulae 1 and 2;
R1 to R16 are the same as or different from each other, and are each independently —CRR′— or —NR″—,
at least two of R1 to R10 are —NR″—,
at least two of R11 to R16 are —NR″—, and
R, R′, and R″ are the same as or different from each other, and are each independently hydrogen or a substituted or unsubstituted alkyl group.

2. The composition of claim 1, wherein R3, R8, R12, and R15 are —NR″—, and
R″ is the same as those defined in Chemical Formulae 1 and 2.

3. The composition of claim 1, wherein each of the compound of Chemical Formula 1 and the compound of Chemical Formula 2 is included in an amount of 0.1 wt % to 0.3 wt % based on a total weight of the composition for forming an active layer.

4. The composition of claim 1, further comprising: a surfactant; a hydrophilic polymer compound; and a solvent.

5. A method for producing a separation membrane, the method comprising:
preparing a porous layer; and
producing an active layer on the porous layer using the composition of claim 1.

6. The method of claim 5, wherein the producing of the active layer using the composition for forming an active layer comprises interfacial polymerization of the composition for forming an active layer and an organic solution comprising an acyl halide compound.

7. The method of claim 5, wherein the preparing of the porous layer comprises:
preparing a first porous support; and
producing a second porous support on the first porous support.

8. The method of claim 7, wherein the first porous support is a non-woven fabric, and
the second porous support is a polysulfone layer.

9. The method of claim 5, further comprising:
producing a protective layer on the active layer after producing the active layer.

10. A separation membrane comprising the composition of claim 1, wherein a salt rejection measured under conditions of 2,000 ppm of an aqueous MgSO₄ solution, a pressure of 130 psi, a temperature of 25° C., and 4 L/min is 99.7% or more, and
a permeate flux is 21 GFD or more.

11. A separation membrane comprising the composition of claim 1, wherein the separation membrane satisfies the following Equation 1:
0.28≤Aa/Ab≤0.50 <Equation 1>
wherein in Equation 1:
Aa means an absorbance value at a wave number of 1640 cm⁻¹ during an FT-IR analysis, and
Ab means an absorbance value at a wave number of 1587 cm⁻¹ during an FT-IR analysis.

12. A water treatment module comprising one or more of the separation membranes of claim 10.

13. A composition for forming a separation membrane active layer, the composition comprising a compound of the following Chemical Formula 1 and a compound of the following Chemical Formula 2,
wherein the compound of the following Chemical Formula 1 is included in an amount of 0.11 wt % to 0.21 wt % based on a total weight of the composition for forming an active layer,
wherein the compound of the following Chemical Formula 2 is included in an amount of 0.14 wt % to 0.25 wt % based on a total weight of the composition for forming an active layer, and
a pH thereof is 11 to 12.7: 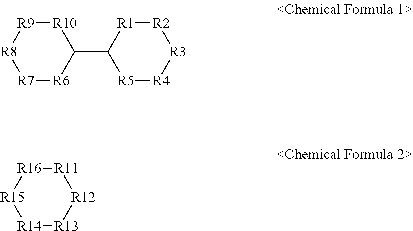
wherein in Chemical Formulae 1 and 2:
R1 to R16 are the same as or different from each other, and are each independently —CRR′— or —NR″—;
at least two of R1 to R10 are —NR″—;
at least two of R11 to R16 are —NR″—; and
R, R′, and R″ are the same as or different from each other, and are each independently hydrogen or a substituted or unsubstituted alkyl group.

14. The composition of claim 13, wherein:
the compound of Chemical Formula 1 is included in an amount of 0.11 wt % based on a total weight of the composition for forming an active layer and wherein the compound of Chemical Formula 2 is included in an amount of 0.25 wt % based on a total weight of the composition for forming an active layer; or
the compound of Chemical Formula 1 is included in an amount of 0.14 wt % based on a total weight of the composition for forming an active layer and wherein the compound of Chemical Formula 2 is included in an amount of 0.21 wt % based on a total weight of the composition for forming an active layer; or
the compound of Chemical Formula 1 is included in an amount of 0.18 wt % based on a total weight of the composition for forming an active layer and wherein the compound of Chemical Formula 2 is included in an amount of 0.18 wt % based on a total weight of the composition for forming an active layer; or
the compound of Chemical Formula 1 is included in an amount of 0.21 wt % based on a total weight of the composition for forming an active layer and wherein the compound of Chemical Formula 2 is included in an amount of 0.14 wt % based on a total weight of the composition for forming an active layer.
